(19) United States
(12) Patent Application Publication
(10) Pub. No.: US 2015/0328999 A1
(43) Pub. Date: Nov. 19, 2015

(54) ELECTRIC CHARGING CENTER WITH FAST-CHARGING STATIONS

(71) Applicant: Enrichment Technology Deutschland GmbH, Jülich (DE)

(72) Inventors: GUILLAUME DUREAU, PARIS (FR); RAINER VOR DEM ESCHE, HEINSBERG (DE); CHRISTOPH TREPPMANN, AACHEN (DE)

(73) Assignee: ENRICHMENT TECHNOLOGY DEUTSCHLAND GmbH, JÜLICH (DE)

(21) Appl. No.: 14/388,163

(22) PCT Filed: Mar. 20, 2013
(86) PCT No.: PCT/EP2013/055820

§ 371 Date: Sep. 25, 2014

(30) Foreign Application Priority Data
Apr. 3, 2012 (EP) 12163007.3

(51) Int. Cl. B60L 11/18

(52) U.S. Cl. CPC B60L 11/185; B60L 11/1824; B60L 11/1851; B60L 11/1803

(57) ABSTRACT

An electric-vehicle charging facility is disclosed having at least one load-cycling-resistant energy-storage device. The electric-vehicle charging facility comprises at least one fast-charging station, hooked up to the AC power supply system that is connected via a transfer point to the general power grid, and comprises at least one load-cycling-resistant energy-storage device having an energy-storage device control unit, whereby the load-cycling-resistant energy-storage device is connected via an AC/DC transformer to the AC power supply system the electric-vehicle charging facility in order to store energy drawn from the general power grid and in order to deliver electric energy to the AC power supply system of the electric-vehicle charging facility response to the demand.

### FIELD OF THE INVENTION

The invention relates to an electric-vehicle charging facility having at least one load-cycling-resistant energy-storage device, suitable for the parallel fast charging of several mobile storage devices, it also relates to a method for the operation of such an electric-vehicle charging facility, and to a method for retrofitting a conventional electric-vehicle charging facility in order to create the electric-vehicle charging facility according to the invention.

### BACKGROUND OF THE INVENTION

An electric vehicle with an electric drive is superior to a conventional vehicle with an internal combustion engine in many aspects. These include, for example, the much higher efficiency as well as the advantageous torque and performance characteristics of the electric motor, the usually simpler construction of the drive train, and the fact that it is almost completely emission-free in terms of pollutants and noise on the local level. Electric cars are thus very well-suited as emission-free vehicles, especially in urban areas. However, in comparison to vehicles with internal combustion engines, today's electric vehicles usually have considerably shorter driving ranges due to the small charging capacities of the energy-storage devices in the vehicles, typically batteries. At the present time, the batteries of electric vehicles still require a prolonged charging time (several hours), so that, for instance, the discharged batteries are charged at home overnight or during the day at the workplace. Smaller electric vehicles have a small battery capacity and can be charged employing simple means (regular household outlets with 230 V, 16 A). However, with these charging means, the electric vehicle is limited to a small radius of action around the charging facility that is used on a daily basis. Electric vehicles with larger batteries can also be charged in a charging station having an electric three-phase power connection of 400 V, 32 A.

In order to ensure continuous mobility of electric vehicles over longer distances without involving long charging times, discharged batteries, for example, can be very quickly swapped for fully charged batteries in a network of battery swapping stations. However, these battery swapping stations would have to keep a large supply of batteries on hand in order to be able to have a sufficient number of charged batteries available at all times, which would be challenging and cost-intensive in terms of the logistics and supply infrastructure.

In order to increase the user-friendliness of electric vehicles, efforts are aimed at achieving faster charging (electric charging). Charging times of one hour can easily be achieved if the output required for this is available and if the vehicles are equipped with the charging devices. The charging of conventional vehicles equipped with batteries having an energy capacity of 12 to 20 kWh requires at least a three-phase connection of 16 A (11 kW) or 32 A (22 kW). However, charging times of about one hour are still much too long for electric vehicles that are being driven over long distances. So-called fast-charging stations could charge the electric energy needed to drive over 150 kilometers (about 30 kWh) in 10 to 20 minutes from the power network into fast-chargeable vehicle batteries, for example, lithium-ion batteries. This would avoid the need for the logistical and technical resources of a battery swapping station involving a large supply of batteries being kept on hand there. However, providing very high currents is usually not possible due to restrictions that exist in the general power grid (for example, the limitation of the available quantity of electricity through the main service fuse of the network connection).

German patent application DE 10 2008 052 827 A1 describes an autonomous electric-vehicle charging facility with which such power grid restrictions are overcome in that the electric energy needed for the charging is generated and provided directly at the site of the electric-vehicle charging facility. The electric energy is generated on site at the electric-vehicle charging facility by a system for the utilization of renewable energy, for example, by a wind farm, whereby an electrolysis system places it into intermediate storage in the form of hydrogen. The electric energy for fast-charging the vehicle batteries is then recovered from the hydrogen energy-storage device by a fuel cell and supplied to the charging stations of the electric-vehicle charging facility at outputs of more than 100 kW. For example, a 250-kW charging facility can supply a lithium-ion battery with 20 kWh of energy within 5 minutes, which translates into a range of 150 to 200 kilometers for the electric vehicles of the future and which is acceptable to customers in terms of the charging time.

The autonomous (local) generation and provision of electric energy in combination with an intermediate energy-storage device calls for a great deal of technical resources for the combined operation of an energy generation unit, an energy storage unit, and an energy recovery unit as part of the electric-vehicle charging facility, and this is accordingly cost-intensive. A less expensive solution for supplying high charging currents is thus desirable, and if possible, it should be suitable for the parallel charging of several vehicle batteries. In particular, it would be desirable if existing charging facilities having conventional power connections to the general power grid could be retrofitted with suitable fast-charging stations without a need for the above-mentioned complicated infrastructure measures, especially if the charging facilities do not have the necessary room to add energy generation systems for autonomous operation that would occupy a great deal of space.

### SUMMARY OF THE INVENTION

It is the objective of the present invention to put forward a reliable electric-vehicle charging facility that is suitable for the parallel fast charging of several mobile storage devices.

This objective is achieved by an electric-vehicle charging facility having an AC power supply system, suitable for the parallel fast charging of several mobile storage devices, comprising at least one fast-charging station, hooked up to the AC power supply system that is connected via a transfer point to the general power grid, and comprising at least one load-cycling-resistant energy-storage device having an energy-storage device control unit, whereby the load-cycling-resistant energy-storage device is connected via an AC/DC transformer to the AC power supply system of the electric-vehicle charging facility in order to store electric energy drawn from the general power grid and in order to deliver electric energy to the AC power supply system of the electric-vehicle charging facility in response to the demand, whereby the demand for additional electric energy is determined by at least one suitable means in the electric-vehicle charging facility, and this means is configured to transmit an appropriate demand signal to the energy-storage device control unit whose function, after the demand signal has been received, is to initiate the delivery of electric energy to the AC power supply system in such a way that neither the general power grid nor the AC power supply system of the electric-vehicle charging facility is overloaded by the parallel fast charging operations.

The general power grid (regular AC network) is operated at 400 V and has a capacity, for instance, of 160 kW. Nowadays, depending on the charging state and the storage capacity of the mobile storage device that is to be charged, fast-charging stations can draw an output of, for example, up to 100 kW per charging station from the AC power supply system of the electric-vehicle charging facility. Since the currents needed for the fast-charging operations can considerably exceed the permissible limit values for a brief period of time, the AC power supply system for the electric-vehicle charging facility according to the invention has to be selected suitably, for example, by installing power lines that are approved for such high currents. In this context, the technical configuration of the AC power supply system depends on the number and type of fast-charging stations in the electric-vehicle charging facility and should be dimensioned in such a way that, via the installed electric lines, the total current that can be anticipated during a fast-charging operation—conceivably the parallel fast charging of several mobile storage devices—can flow through all of the existing fast-charging stations without any safety problems. If the person skilled in the art knows the number and type of fast-charging stations, he will be able to select the suitable electric power lines for the AC power supply system of the electric-vehicle charging facility. If the electric-vehicle charging facility is supplied only from the general power grid, this would lead to overloading of the general power grid, which, under certain circumstances, might even cause a collapse of the power supply. The normal general power grid supplies, for example, 160 kW. Even with the operation of just a single fast-charging station, in the case of a full output of the fast-charging station and a weak general power grid, it is possible that the general power grid in an electric-vehicle charging facility according to the state of the art might become overloaded. This is especially in case of a parallel fast charging of several electric vehicles by means of several fast-charging stations, especially if this is done at a high output.

The general power grid is connected to the AC power supply system of the electric-vehicle charging facility at a transfer point. The transfer point can be configured, for example, as a load interrupter or as a main service fuse. If it is a main service fuse, it would be triggered in case of an overload, thereby interrupting the power supply of the electric-vehicle charging facility. The more fast-charging stations are available at an electric-vehicle charging facility, the more often such an overload state can occur in electric-vehicle charging facilities that do not have additional extra energy-storage devices, especially in view of the rising number of electric vehicles that can be expected in the future. Consequently, electric-vehicle charging facilities according to the invention comprise at least one load-cycling-resistant energy-storage device that is connected via an AC/DC transformer to the AC power supply system of the electric-vehicle charging facility in order to deliver electric energy to the AC power supply system. Such energy-storage devices can briefly supply, for example, an output of 500 kW or more (depending on the storage capacity) in case the demand has arisen during the simultaneous electric charging of several electric vehicles, without there being a need for the general power grid to provide power for the AC power supply system of the electric-vehicle charging facility and thus without the general power grid being overloaded. Consequently, the output limitation that exists with the general power grid output of, for example, 160 kW is overcome at least for a certain period of time that is a function of the storage capacity and of the charging state of the load-cycling-resistant energy-storage device. Therefore, depending on the size of the mobile storage device such as, for example, batteries in the electric vehicles, it is possible for more vehicles to be charged in parallel and within a shorter period of time. In one embodiment, the electric-vehicle charging facility comprises several fast-charging stations that are arranged parallel to each other in the AC power supply system. Thanks to the shorter charging time and/or to the availability of many fast-charging stations at an electric-vehicle charging facility for many customers, better service (shorter waiting times) is offered to the customers of the electric-vehicle charging facility. Thus, for example, a 250 kW charging station can provide lithium-ion batteries with 20 kWh of energy within 5 minutes, and even in less time at a higher output. Moreover, the general power grid infrastructure is not overloaded. Consequently, an expensive expansion of the general power grid to supply electric-vehicle charging facilities can be avoided, and the existing infrastructure of the electric-vehicle charging facilities can continue to be used. The load-cycling-resistant energy-storage devices are dimensioned in such a way that they can supply the output needed for the fast charging—which depends on the number of fast-charging stations—for a prolonged period of time, for example, for one or more hours, before these energy-storage devices will have become discharged. Consequently, there are sufficient buffer times when there is no demand for additional energy, and these periods of time are used for the recharging (storage) of the load-cycling-resistant energy-storage device.

The mobile storage device can be, for example, a flywheel or another storage device of an electric vehicle that is suitable for storing energy stemming from electricity. In one embodiment, the mobile storage device is the battery of an electric vehicle.

In contrast to the power delivery (delivery of electric energy) to the AC power supply system, the load-cycling-resistant energy-storage device can be continuously recharged from the general power grid via the hooked-up AC/DC transformer over longer periods of time during which the power demand of the electric-vehicle charging facility—especially for electric charging operations from the general power grid—can be met without the grid being overloaded. Thus, the general power grid is burdened more or less uniformly by the output drawn by the electric-vehicle charging facility for the electric charging operations and for the charging of the energy-storage devices. As a result, the power drawn from the general power grid is rendered more uniform and predictable, which translates into a reduction of the power costs through lower electricity rates. The energy-storage devices that are suitable for the electric-vehicle charging facility according to the invention are load-cycling-resistant energy-storage devices, since brief periods of time with a high load delivery for the parallel charging of several mobile storage devices from the energy-storage device alternate with periods of time with a lower load delivery or none at all (periods that can be used for recharging the energy-storage device), as a result of which the load drawn from the energy-storage device fluctuates a great deal over the course of time. Suitable load-cycling-resistant energy-storage devices are mechanical or else certain electric energy-storage devices such as, for example, flywheel energy-storage devices, compressed air storage devices, liquefied air storage devices or supercapacitors. Batteries, in contrast, are only suitable to a certain extent since they lack load-cycling resistance for the frequent load-cycling operations in electric-vehicle charging facilities. Moreover, these storage devices are also superior to batteries in that the full storage capacity is available to deliver electric energy to the AC power supply system of the electric-vehicle charging facility. In contrast, batteries should only be discharged to a certain level since so-called exhaustive discharges damage the battery. This is not the case with the above-mentioned load-cycling-resistant energy-storage devices. Moreover, energy-storage devices that are not load-cycling-resistant would quickly age or be damaged if used to operate an electric-vehicle charging facility, so that these energy-storage devices that are not load-cycling-resistant would have to be replaced frequently, thereby greatly increasing the operating costs and the work requirements in the electric-vehicle charging facility, and also reducing the availability of the electric-vehicle charging facility for multiple parallel electric charging operations.

The energy-storage device control unit controls the withdrawal/delivery of energy from/into the AC power supply system of the electric-vehicle charging facility. An energy-storage device control unit is, for example, a control computer (control PC) that controls the appropriate hardware of the load-cycling-resistant energy-storage device via suitable interfaces. In one embodiment, the energy-storage device control unit charges the load-cycling-resistant energy-storage device from the general power grid on the basis of a consumption prediction or on the basis of a prescribed profile, taking into account the charging state of the load-cycling-resistant energy-storage device. Consumption predictions can be derived, for example, from a measured consumption history. For this purpose, the electric-vehicle charging facility is equipped, for example, with a consumption sensor, preferably with several consumption sensors, that are arranged in or on the charging station(s) (fast-charging stations) that is/are connected to a hooked-up evaluation and storage unit. In order to control the energy delivery/storage, the energy-storage device control units are connected to the evaluation and storage unit via data lines. As an alternative, a charging profile of the energy-storage device can be specified that prescribes the target state of the capacity of the energy-storage device. The energy-storage device control units strive to reach the target state by delivering or taking up energy. Here, however, in order to avoid overloading the power grid, the delivery of energy to the AC power network of the electric-vehicle charging facility in response to the demand has priority over the charging of the energy-storage device. As an alternative, the means for determining the demand can be in the form of a consumption sensor, whereby the evaluation and storage unit can also be arranged as a component in the energy-storage device control unit.

The suitable means for determining the demand for additional electric energy that, in response to the determination, transmits a demand signal to the energy-storage device control unit can be selected by the person skilled in the art in a suitable manner within the scope of the present invention. An example of a suitable means can be the fact that the system detects every electric vehicle that drives into the electric-vehicle charging facility, for instance, by means of optical recognition of electric vehicles at the charging stations (fast-charging stations) of the electric-vehicle charging facility. The detection of electric vehicles at the fast-charging stations and the resultant estimate of the demand for energy could be achieved by induction loops embedded in the ground around the fast-charging stations. However, this would only constitute a very indirect and imprecise estimate of the anticipated power demand because of the unknown charging state of the mobile storage device in the electric vehicle. As an alternative suitable means, the charging state of the mobile storage device of the electric vehicle before the electric charging operation could be determined by means of the charging station (fast-charging station) that is hooked up to the mobile storage device. The determination of the charging state can be used concurrently to detect the presence of an electric vehicle that is to be charged. In this manner, the demand for additional electric energy for the electric charging operation can be estimated much more precisely. In a preferred embodiment, the suitable means for determining the demand for additional electric energy, can be one or more load sensors arranged at least in the AC power supply system of the electric-vehicle charging facility upstream from the transfer point. The expression “upstream from the transfer point” refers to the side of the power supply that is between the transfer point and the fast-charging stations, in other words, in the area of the AC power supply system of the electric-vehicle charging facility. Here, the actual power demand in the AC power network of the electric-vehicle charging facility is measured, as a result of which the power feed from the load-cycling-resistant energy-storage device can be controlled very precisely in order to avoid an overload of the power grid. The person skilled in the art can select the suitable load sensors within the scope of the present invention and can arrange them at a suitable place in the AC power supply system of the electric-vehicle charging facility. Preferably, the load sensors are arranged between the transfer point and the AC/DC transformer. In an alternative embodiment, the load sensors can also be situated in the charging station (fast-charging station), as a result of which the load picked up by the specific charging station (fast-charging station) is measured individually for each charging station (fast-charging station), and subsequently, a precise consumption prediction can be drawn up on the basis of the measured data. The load sensors can thus likewise be used as consumption sensors.

In one embodiment, the load-cycling-resistant energy-storage device is a flywheel energy-storage device having several storage units, each having a flywheel, whereby the storage units are connected to each other via a DC bus and to the AC power supply system of the electric-vehicle charging facility via the AC/DC transformer. The plurality of storage units makes it possible to create an energy-storage device with a suitably high capacity, whereby the capacity can be adapted to the demand of the electric-vehicle charging facility by selecting a suitable number of storage units. Flywheel energy-storage devices have a low fire load as compared to electrochemical storage devices. The term “fire load” refers to the amount and type of flammable material at a given place expressed as the surface-related heating energy value per unit area. By the same token, there is no risk of explosions—as is the case with compressed air storage devices—in case of damage to the pressurized air tank or to the associated lines. The containment of the flywheel energy-storage device offers sufficient protection against rupture of the flywheel. Moreover, flywheel energy-storage devices do not suffer ageing due to load cycles, so that the flywheel energy-storage devices can be operated for a very long time while needing very little maintenance as compared to other energy-storage devices. Furthermore, such storage devices do not generate any emissions at all (such as, for instance, CO₂, noise, or toxic substances). This emission-free energy-storage device can be set up anywhere without local restrictions.

In a preferred embodiment, the flywheel energy-storage device is configured in such a way that the voltage on the DC bus is largely independent of the charging state of the flywheel energy-storage device, especially of the storage units. As a result, the individual storage units can be discharged independently of each other, in response to the demand.

In another embodiment, the electric-vehicle charging facility comprises additional load-cycling-resistant energy-storage devices that are each connected via another AC/DC transformer to the AC power supply system of the electric-vehicle charging facility in order to store electric energy drawn from the general power grid and in order to deliver electric energy to the AC power supply system of the electric-vehicle charging facility in response to the demand. Thus, the total capacity for stored energy can be increased without the individual energy-storage device having to be modified for this purpose. This facilitates the capacity expansion whenever this is needed and reduces the technical measures necessary for this purpose, for example, in comparison to the complicated installation of additional storage units in an already existent flywheel energy-storage device. Moreover, electric-vehicle charging facilities according to the invention can be provided with new additional fast-charging stations arranged in parallel in the AC power supply system since the subsequently required higher total amount of energy can be made available by additionally installed load-cycling-resistant energy-storage devices as a function of the demand, likewise without involving a great deal of resources. The AC power supply system does not have to be adapted any further for this purpose. In a preferred embodiment, the energy-storage device control units of the load-cycling-resistant energy-storage devices are connected via a charge management unit to the means for determining the demand for additional electric energy, whereby, depending on the charging state of the load-cycling-resistant energy-storage devices, the charge management unit selects one or several load-cycling-resistant energy-storage devices for the storage of electric energy drawn from the general power grid and for the delivery of electric energy to the AC power supply system, and this charge management unit actuates the individual energy-storage device control units of the load-cycling-resistant energy-storage devices accordingly. As a result, the energy-storage devices can be suitably operated on the basis of the demand and of the storage capacity.

In another embodiment, the electric-vehicle charging facility comprises one or more energy generation units that are arranged in such a way that, depending on the type of current generated, they feed the current into the electric-vehicle charging facility either upstream or downstream from the AC/DC transformer. Such energy generation units are, for example, photovoltaic systems, wind farms or combined heat and power plants. In this context, the expression “upstream or downstream” refers to the arrangement of the energy generation units relative to the arrangement of the AC/DC transformer. The term “downstream from the AC/DC transformer” refers to a connection of the energy generation units on the AC side in the AC power supply system of the electric-vehicle charging facility. The term “upstream from the AC/DC transformer” refers to a connection of the energy generation units on the DC side between the AC/DC transformer and the load-cycling-resistant energy-storage device, for example, on the DC bus of the electric-vehicle charging facility. Depending on whether the energy generation units supply AC current or DC current, they are arranged downstream (AC side) or upstream (DC side) from the AC/DC transformer. Such additional energy generation units are especially advantageous if the electric-vehicle charging facility is only hooked up to a weak general power grid that, for example, needs very long period of time to charge the load-cycling-resistant energy-storage device with energy. Here, the energy generation units assist in the provision of electric energy from the general power grid or in the recharging of the load-cycling-resistant energy-storage device with energy. Since the required or desired level of assistance can vary during the energy provision, the energy generation units can be dimensioned very differently, and according to the invention, energy can also be fed in from smaller energy generation units. The energy generation units can be, for instance, energy generation units installed locally on the grounds of the electric-vehicle charging facility. In principle, electric-vehicle charging facilities could also be created without a connection to the above-mentioned general power grid, as long as these additional energy generation units deliver enough electric energy to the AC or DC power network of the electric-vehicle charging facility. In such an embodiment, said energy generation units would constitute the general power network for the electric-vehicle charging facility. In this case, at least one of the energy generation units is connected at the transfer point to the AC power supply system or to the DC bus of the electric-vehicle charging facility.

The invention also relates to a method for the operation of an electric-vehicle charging facility according to the present invention having an AC power supply system, suitable for the parallel fast charging of several mobile storage devices, comprising at least one fast-charging station, preferably several fast-charging stations, hooked up to the AC power supply system that is connected to the general power grid via a transfer point, and comprising at least one load-cycling-resistant energy-storage device having an energy storage device control unit connected to at least one suitable means for determining the demand for additional electric energy in the AC power supply system, comprising the following steps:

the load-cycling-resistant energy-storage device is charged via the AC/DC transformer from the general power grid if the load-cycling-resistant energy-storage device is not yet fully charged and if no demand for additional electric energy in the electric-vehicle charging facility was determined by the suitable means, and

electric energy is delivered to the AC power supply system of the electric-vehicle charging facility from the load-cycling-resistant energy-storage device, initiated by the energy-storage device control unit, so that neither the general power grid nor the AC power supply system of the electric-vehicle charging facility is overloaded by the parallel fast-charging operations, once the demand for additional electric energy has been determined by the suitable means and an appropriate demand signal has been sent to the energy-storage device control unit. Consequently, the general power grid is not overloaded, even in case of an higher power demand caused by a fast-charging operation at a higher output than is available from the general power grid and/or because several electric vehicles have to be charged simultaneously (demand case), since the energy-storage device supplies the output that exceeds the power grid capacity directly to the electric-vehicle charging facility. As a result, this permits a parallel fast charging of several electric vehicles within just a few minutes, something that would not be possible without electric energy from the load-cycling-resistant energy-storage device being delivered to the AC power supply system of the electric-vehicle charging facility. In the periods of time without an higher power demand, the energy-storage device is recharged from the general power grid, whereby the charging is carried out over a longer period of time (far longer than the period of time for charging the electric vehicles). As a result, the energy-storage device can be supplied with the energy needed for the later fast charging of the electric vehicles, and this is done without overloading the general power grid. The connection of the energy-storage device to the AC power supply system of the electric-vehicle charging facility also permits any electric-vehicle charging facility to be equipped with the load-cycling-resistant energy-storage device, without a need to modify the previously existing AC power supply system of the electric-vehicle charging facility.

In one embodiment, the charging of the load-cycling-resistant energy-storage device is based on a consumption prediction or on a prescribed profile, taking into account the charging state of the load-cycling-resistant energy-storage device.

In another embodiment of the method, whereby the electric-vehicle charging facility comprises additional load-cycling-resistant energy-storage devices that are each connected via an additional AC/DC transformer to the AC power supply system of the electric-vehicle charging facility, and whereby the energy-storage device control units of the load-cycling-resistant energy-storage devices are connected via a charge management unit to the means for determining the demand for additional electric energy, the method comprises the following steps:

one or several load-cycling-resistant energy-storage devices for the storage of electric energy drawn from the general power grid are selected by the charge management unit, depending on the charging state of the load-cycling-resistant energy-storage devices in the absence of a demand for additional electric energy in the AC power supply system, and

one or several load-cycling-resistant energy-storage devices for the delivery of electric energy to the AC power supply system are selected, and subsequently, the selected load-cycling-resistant energy-storage devices are actuated by the appertaining energy-storage device control units of the load-cycling-resistant energy-storage devices. The use of several separate load-cycling-resistant energy-storage devices increases the total capacity of stored energy, without the individual energy-storage devices having to be modified for this purpose. This allows a modular capacity adaptation. Depending on the demand and on the charging state of the individual energy-storage devices, after an appropriate selection has been made by the charge management unit (for example, by sending a selection signal to the appropriate energy-storage device control unit that is connected to the charge management unit via data lines), one, several or all of the energy-storage devices can deliver energy to the AC power supply system of the electric-vehicle charging facility.

The invention also relates to a method for retrofitting an electric-vehicle charging facility having an existing AC power supply system that is connected to the general power grid via a transfer point in order to create an electric-vehicle charging facility according to the present invention having a load-cycling-resistant energy-storage device, suitable for the parallel fast charging of several mobile storage devices, comprising the following steps:

the AC power supply system of the electric-vehicle charging facility is adapted to the total current that can be anticipated for the parallel fast-charging, if the existing AC power supply system is not suitable for this total current,

the load-cycling-resistant energy-storage device is hooked up by means of an AC/DC transformer to the conceivably adapted AC power supply system of the electric-vehicle charging facility in order to store electric energy drawn from the general power grid and in order to deliver electric energy to the AC power supply system of the electric-vehicle charging facility in response to the demand,

a suitable means, preferably comprising one or more load sensors, for determining the demand for additional electric energy is incorporated into the electric-vehicle charging facility, and

the means is connected to an energy-storage device control unit of the load-cycling-resistant energy-storage device, said unit being provided to initiate the delivery of electric energy to the AC power supply system on the basis of the determined demand, so that neither the general power grid nor the AC power supply system of the electric-vehicle charging facility is overloaded by the parallel fast-charging operations.

Before an additional energy-storage device is integrated into the AC power network of the electric-vehicle charging facility in order to deliver energy, first or all, it has to be checked whether the existing AC power supply system is dimensioned for the currents that might flow during a conceivable parallel fast-charging operation using the hooked-up energy-storage device. If the AC power supply system is not suitable for these anticipated currents, then first an appropriately suitable AC power supply system has to be installed. This installation work, however, is limited to the area up to the transfer point, since the high currents are not drawn from general power grid, but rather, they are made available by the load-cycling-resistant energy-storage device. Since the load-cycling-resistant energy-storage device is integrated into the AC power supply system of the electric-vehicle charging facility by means of an AC/DC transformer, conventional electric-vehicle charging facilities can easily be adapted with an energy-storage device so as to permit a parallel fast charging of several electric vehicles without overloading the general power grid and without having to adapt the general power grid to the higher power demand. This might have to be done by modifying the AC power network of the electric-vehicle charging facility. Moreover, only the above-mentioned components for controlling the energy-storage device have to be integrated into the power network of the electric-vehicle charging facility. The hooked-up general power grid can continue to be used as before. This greatly reduces the technical resources needed for retrofitting an already existing electric-vehicle charging facility in order to create an electric-vehicle charging facility according to the invention. Moreover, the retrofitting becomes technically feasible for almost any electric-vehicle charging facility. Within the scope of the present invention, the above-mentioned method steps for the retrofitting in order to create an electric-vehicle charging facility according to the invention can also be carried out by the person skilled in the art in a different order than the one given above.

In one embodiment, on the basis of an appropriate demand prognosis, the steps consisting of hooking up, incorporating and connecting can be carried out for additional load-cycling-resistant energy-storage devices that are then each connected via another AC/DC transformer to the AC power supply system of the electric-vehicle charging facility. Thus, even in case of differing power demands, any electric-vehicle charging facility can be retrofitted with the suitable energy-storage devices that they need.

### BRIEF DESCRIPTION OF THE FIGURES

These and other aspects of the invention are shown in detail in the figures as follows:

FIG. 1 an electric-vehicle charging facility according to the state of the art;

FIG. 2 an embodiment of the electric-vehicle charging facility according to the invention;

FIG. 3 another embodiment of the electric-vehicle charging facility according to the invention, with several load-cycling-resistant energy-storage devices;

FIG. 4 an embodiment of the load-cycling-resistant energy-storage device in the form of a flywheel energy-storage device;

FIG. 5 an embodiment of the method for operating an electric-vehicle charging facility according to the invention;

FIG. 6 an embodiment of the method for retrofitting a conventional electric-vehicle charging facility in order to create an electric-vehicle charging facility according to the invention.

### DETAILED DESCRIPTION OF THE EMBODIMENTS

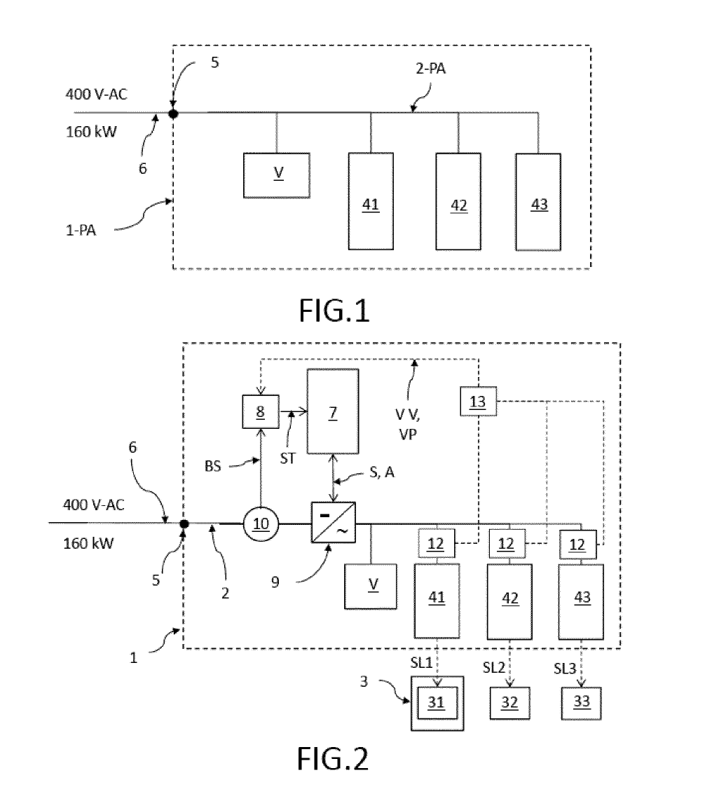

FIG. 1 shows an electric-vehicle charging facility 1-PA according to the state of the art, whereby the electric-vehicle charging facility 1-PA has an AC power supply system 2-PA that is connected at a transfer point 5 (for example, a main service fuse) to the general power grid 6 with 400 V-AC and 160 kW. The electric-vehicle charging facility 1-PA according to the state of the art can have one or more charging stations 41, 42, 43 that can optionally also be configured as fast-charging stations. Due to the limitations associated with the general power grid 6, the charging stations 41, 42, 43 cannot be used in parallel and/or only with a limited charging output whenever there is a high charging demand. Particularly when there is a large number of electric vehicles to be charged at the electric-vehicle charging facility 1-PA, this results in long waiting times for the charging and thus in long waiting times for the electric vehicles, which would greatly restrict the times when such vehicles are operational. The component V here refers to the sum of all of the other power consumers of the electric-vehicle charging facility 1-PA that are not fast-charging stations such as, for example, the lighting of the electric-vehicle charging facility and the operation of other electric systems of the electric-vehicle charging facility.

FIG. 2 shows an embodiment of the electric-vehicle charging facility 1 according to the invention (schematically depicted as an area surrounded by a broken line) with an AC power supply system 2, suitable for the parallel fast charging SL1, SL2, SL3 of several mobile storage devices 31, 32, 33 of electric vehicles 3. Here, the AC power supply system 2 is suitably configured for particularly high currents above 32 A. In this embodiment, the electric-vehicle charging facility 1 comprises three fast-charging stations 41, 42, 43 hooked up to the AC power supply system 2 that is connected to the general power grid 6 via a transfer point 5. In other embodiments, the number of fast-charging stations can be very different, for example, ranging from one fast-charging station to ten or more fast-charging stations. In addition, the electric-vehicle charging facility 1 has at least one load-cycling-resistant energy-storage device 7 having an energy-storage device control unit 8, which here is arranged as a separate unit. In other embodiments, the energy-storage device control unit 8 can also be arranged as a component in the energy-storage device 7. The load-cycling-resistant energy-storage device 7 is connected via an AC/DC transformer 9 to the AC power supply system 2 of the electric-vehicle charging facility 1, so that electric energy drawn from the general power grid 6 can be stored S and, in response to the demand B, electric energy can be delivered A to the AC power supply system 2 of the electric-vehicle charging facility 1. The demand B for additional electric energy is determined here by a load sensor 10 as the suitable means 10 in the electric-vehicle charging facility 1. Here, the load sensor is arranged between the AC/DC transformer 9 and the transfer point 5, and it is connected via a data line to the energy-storage device control unit 8 for purposes of transmitting the load data. The load sensor 10 is configured to transmit an appropriate demand signal BS to the energy-storage device control unit 8, in response to which, after receiving the demand signal BS, the energy-storage device control unit 8 initiates the delivery A of electric energy to the AC power supply system 2 via an appropriate control signal ST in such a way that neither the general power grid 6 nor the AC power supply system 2 of the electric-vehicle charging facility 1 is overloaded by the parallel fast charging SL1, SL2, SL3 (broken-line arrows). The subsequent charging S of the energy-storage device 7 can be based on a consumption prediction VV or on a prescribed profile VP, taking into account the charging state LZ of the load-cycling-resistant energy-storage device 7. For this purpose, by means of consumption sensors 12—here a consumption sensor 12 on each fast-charging station 41, 42, 43—the consumption over time is measured and the data is transmitted via data lines to an evaluation and storage unit 13 in order to generate the consumption prediction VV or the prescribed profile VP. Here, the evaluation and storage unit 13 is connected to the energy-storage device control unit 8 in order to transmit the consumption prediction VV or the prescribed profile VP, so that said evaluation and storage unit 13 appropriately controls the charging S of the energy-storage device 7. In other embodiments, the evaluation and storage unit 13 can also be part of the energy-storage device control unit 8. In another embodiment, the load sensor 10 can be concurrently used as a consumption sensor 12. The component V refers here in total to all of the other power consumers of the electric-vehicle charging facility 1 that are not fast-charging stations such as, for example, the lighting of the electric-vehicle charging facility 1 and the operation of other electric systems of the electric-vehicle charging facility 1.

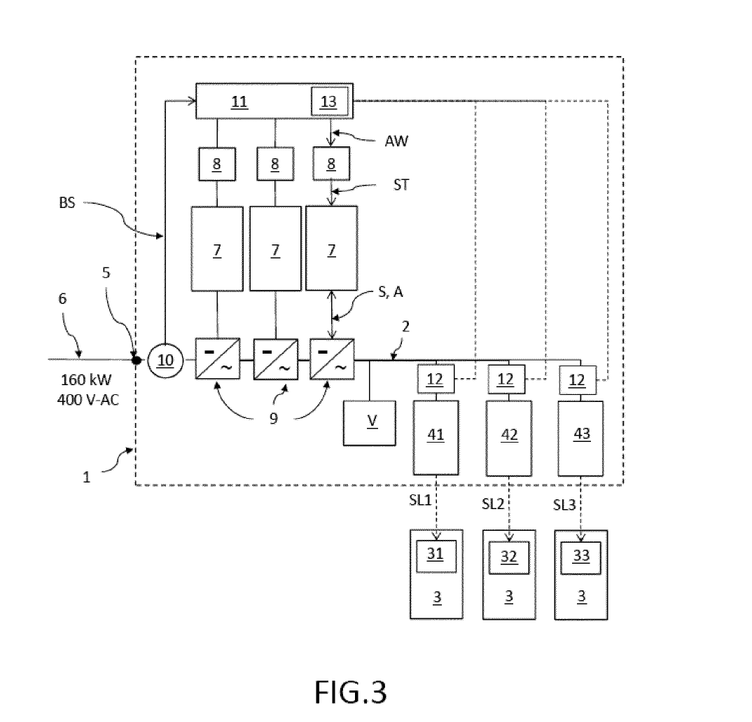

FIG. 3 shows another embodiment of the electric-vehicle charging facility 1 according to the invention with several load-cycling-resistant energy-storage devices 7. The fast-charging stations 41, 42, 43, the AC power supply system 2, the transfer point 5, the load sensor 10, the consumption sensors 12, the consumer V and the general power grid 6 all correspond to the embodiment of FIG. 2. Of course, the number of fast-charging stations 41, 42, 43 for charging batteries 31, 32, 33 of the electric vehicles 3 in FIG. 3 is likewise given merely by way of an example and can vary markedly in other electric-vehicle charging facilities 1 according to the invention. In this embodiment, the electric-vehicle charging facility 1 comprises three load-cycling-resistant energy-storage devices 7 that are each connected via another AC/DC transformer 9 to the AC power supply system 2 of the electric-vehicle charging facility 1 in order to store S electric energy drawn from the general power grid 6 and, in response to the demand B, to deliver A electric energy to the AC power supply system 2 of the electric-vehicle charging facility 1. The energy-storage device control units 8 of the load-cycling-resistant energy-storage devices 7 are connected via a charge management unit 11 to the load sensor 10 for determining the demand B for additional electric energy. The charge management unit 11 is provided so that, depending on the charging state LZ of the load-cycling-resistant energy-storage devices 7, it can select AW one, several or all of the energy-storage devices 7 for the storage S of electric energy drawn from the general power grid 6 and for the delivery A of electric energy to the AC power supply system 2, and these energy-storage devices 7 are appropriately actuated ST by the appertaining energy-storage device control units 8 of the load-cycling-resistant energy-storage devices 7. In this embodiment, the charge management unit 11 has selected only one single load-cycling-resistant energy-storage device 7 for the storage S/delivery A of electric energy, whereas the other two load-cycling-resistant energy-storage devices 7 remain in the stand-by mode. The number of load-cycling-resistant energy-storage devices 7 shown here is only an example for an electric-vehicle charging facility 1 and can vary, depending on the configuration of the electric-vehicle charging facility 1 and on the number of electric vehicles 3 that are to be charged. Moreover, in this embodiment, the evaluation and storage unit 13 shown in FIG. 2 is configured as a component of the charge management unit 11.

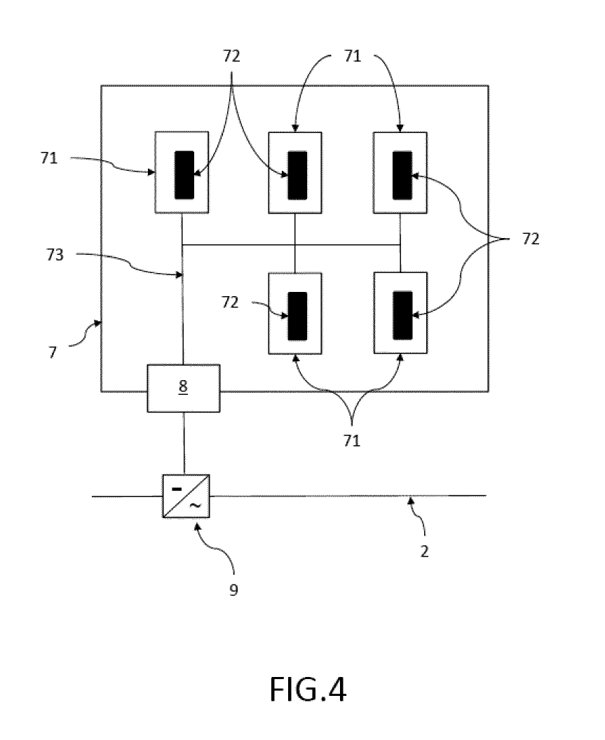

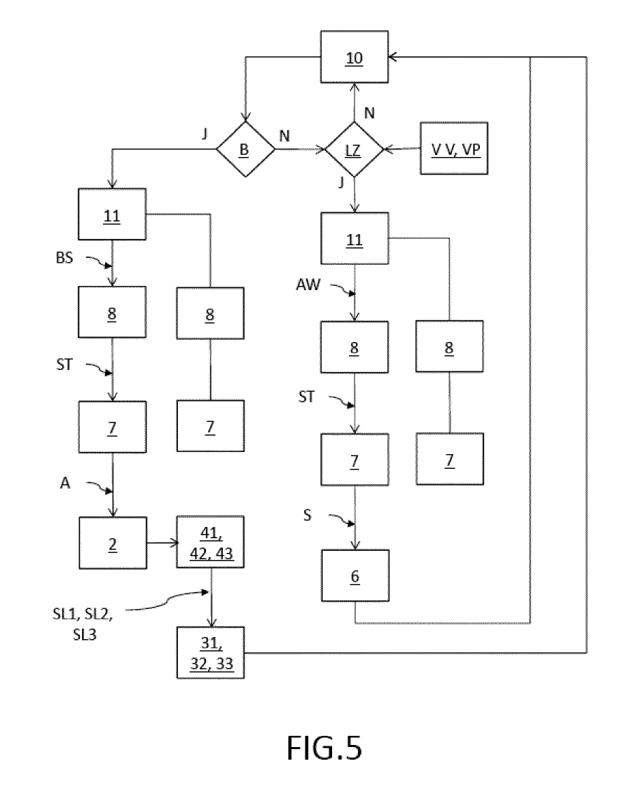

FIG. 4 shows an embodiment of the load-cycling-resistant energy-storage device 7 in the form of a flywheel energy-storage device 7. Here, the flywheel energy-storage device 7 is equipped with several storage units 71, each having a flywheel 72, that are connected to each other via a DC bus 73 and to the AC power supply system 2 of the electric-vehicle charging facility 1 via the AC/DC transformer 9. In this embodiment, the energy-storage device control unit 8 is configured as a component of the flywheel energy-storage device 7, whereby this arrangement is not limited to flywheel energy-storage devices 7. Moreover, the flywheel energy-storage device 7 can be configured in such a way that the voltage on the DC bus 73 is largely independent of the charging state LZ of the flywheel energy-storage device 7 and of the storage units 71.

FIG. 5 shows an embodiment of the method for operating an electric-vehicle charging facility 1 according to the invention. The load sensor 10 first determines whether there is a demand B for additional electric energy in the AC power supply system 2. If this is the case (J=yes), the demand is transmitted accordingly to the charge management unit 11, so that an appropriate demand signal BS for the delivery A of electric energy from the selected load-cycling-resistant energy-storage device 7 to the AC power supply system 2 of the electric-vehicle charging facility 1 is transmitted by the charge management unit 11 to the corresponding energy-storage device control unit 8 which then initiates the delivery A of electric energy to the AC power supply system 2. Consequently, in spite of the fast-charging operations SL1, SL2, SL3 that have been carried out, neither the general power grid 6 nor the AC power supply system 2 of the electric-vehicle charging facility 1 is overloaded. In contrast, if no demand for electric energy (case, N=no) has been determined by the load sensor 10 and if the load-cycling-resistant energy-storage device 7 is not yet fully charged (checking of charging state, J=yes), then the load-cycling-resistant energy-storage device 7 is charged from the general power grid 6 via the AC/DC transformer 9. For this purpose, the charge management unit 11 selects AW the energy-storage device 7 that is to be charged on the basis of the consumption prediction VV or of a prescribed profile VP, so as to then charge the energy-storage device 7 whose energy-storage device control unit 8 employs an appropriate control signal ST to initiate the storage S of electric energy in the energy-storage device 7 drawn from the general power grid 6. Periodically or continuously, the load sensor 10 once again transmits the existent or non-existent demand B to the charge management unit 11, after which the above-mentioned steps are carried out again. In an embodiment involving only one energy-storage device 7, the steps executed by the charge management unit 11 can also be carried out by the energy-storage device control unit 8 itself, whereby no selection AW has to be made since there is only one single energy-storage device 7, whereby in this embodiment, the charge management unit 11 can even be dispensed with under certain circumstances.

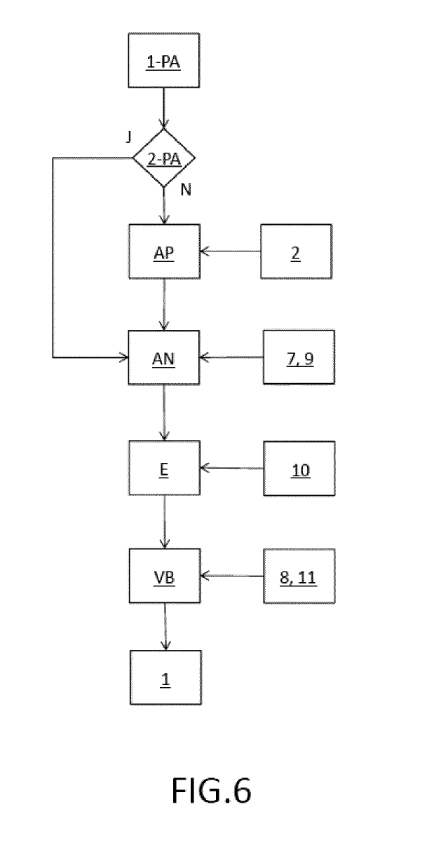

FIG. 6 shows an embodiment of the method for retrofitting a conventional electric-vehicle charging facility 1-PA in order to create an electric-vehicle charging facility 1 according to the invention. The electric-vehicle charging facility 1-PA has an AC power supply system 2-PA that is connected via a transfer point 5 to the general power grid 6. First of all, it is checked whether the AC power supply system 2-PA is suitable to transport high currents during operation of an electric-vehicle charging facility 1 according to the invention having one or more fast-charging stations 41, 42, 43. If this is not the case (N=no), the AC power supply system 2-PA of the electric-vehicle charging facility 1-PA is adapted AP for the total current that can be anticipated for the parallel fast charging SL1, SL2, SL3. If the existent AC power supply system 2-PA is suitable for this total current and if it already constitutes an AC power supply system 2, then this step is skipped. Subsequently (or as an alternative in parallel or before the adaptation of the AC power supply system), the load-cycling-resistant energy-storage device 7 is hooked up AN to the conceivably adapted AC power supply system 2 of the electric-vehicle charging facility 1-PA for the storage S of electric energy drawn from the general power grid 6 and for the delivery A of electric energy to the AC power supply system 2 of the electric-vehicle charging facility 1. Moreover, a suitable means 10 preferably comprising one or more load sensors for determining the demand B for additional electric energy is incorporated E into the electric-vehicle charging facility 1-PA, and the means 10 is connected VB to the energy-storage device control unit 8 of the load-cycling-resistant energy-storage device 7 in order to initiate the delivery A of electric energy to the AC power supply system 2 on the basis of the determined demand B. If applicable, in case of a demand prognosis to this effect, the steps consisting of hooking up AN, incorporating E, and connecting VB are repeated for additional load-cycling-resistant energy-storage devices 7 that are then each connected to the AC power supply system 2 of the electric-vehicle charging facility 1 via an additional AC/DC transformer 9. Depending on the embodiment, one or more charge management units 11 are additionally installed between the load sensor(s) 10 and the energy-storage device control unit(s) 8 for purposes of selecting the energy-storage devices 7 for the storage S or delivery A of electric energy. After the above-mentioned method steps have been carried out, the prior-art electric-vehicle charging facility 1-PA will have been retrofitted with just moderate technical resources in order to create an electric-vehicle charging facility 1 according to the invention. If needed, this retrofitted electric-vehicle charging facility can be appropriately expanded with additional energy-storage devices 7 and/or additional fast-charging stations.

The embodiments shown here are merely examples of the present invention and consequently must not be construed in a limiting manner. Alternative embodiments taken into consideration by the person skilled in the art are likewise encompassed by the scope of protection of the present invention.

### LIST OF REFERENCE NUMERALS

1 electric-vehicle charging facility according to the invention
1-PA electric-vehicle charging facility according to the state of the art
2 AC power supply system in the electric-vehicle charging facility
2-PA AC power supply system in the electric-vehicle charging facility according to the state of the art
3 electric vehicle
31, 32, 33 mobile storage device
41, 42, 43 fast-charging station
5 main service fuse
6 general power grid (e.g. 400 V, 160 kW)
7 load-cycling-resistant energy-storage device
71 storage unit of the energy-storage device
72 flywheel in the storage unit
73 DC bus in the energy-storage device
8 energy-storage device control unit
9 AC/DC transformer
10 means for determining the demand for additional electric energy
11 charge management unit
12 consumption sensor for measuring the power consumption
13 evaluation and storage unit for recording the consumption
A delivery of electric energy in the AC power supply system in the electric-vehicle charging facility
AP adaptation of the AC power supply system of the electric-vehicle charging facility to higher currents
AN hooking up of the energy-storage device 7 to the AC power supply system
AW selection of one/several energy-storage devices 7 for storing/delivering electric energy
B demand for additional electric energy
BS demand signal
E incorporation of the means 10 into the AC power supply system
LZ charging state
S storage of electric energy drawn from the general power grid
SL1, SL2, SL3 fast charging
ST actuation/control of the energy-storage device by the energy-storage device control unit
V other electric consumers of the electric-vehicle charging facility
VB connecting the means 10 to the energy-storage device control unit 8
VP prescribed profile VP
VV consumption prediction

1. An electric-vehicle charging facility having an AC power supply system, suitable for the parallel fast charging of several mobile storage devices, comprising at least one fast-charging station, hooked up to the AC power supply system that is connected via a transfer point to the general power grid, and comprising at least one load-cycling-resistant energy-storage device having an energy-storage device control unit, whereby the load-cycling-resistant energy-storage device is connected via an AC/DC transformer to the AC power supply system of the electric-vehicle charging facility in order to store electric energy drawn from the general power grid and in order to deliver electric energy to the AC power supply system of the electric-vehicle charging facility in response to the demand, whereby the demand for additional electric energy is determined by at least one suitable means in the electric-vehicle charging facility, and this means configured to transmit an appropriate demand signal to the energy-storage device control unit whose function, after the demand signal has been received, is to initiate the delivery of electric energy to the AC power supply system in such a way that neither the general power grid nor the AC power supply system of the electric-vehicle charging facility is overloaded by the parallel fast charging operations.

2. The electric-vehicle charging facility according to claim 1,
characterized in that
the electric-vehicle charging facility comprises several fast-charging stations that are arranged parallel to each other in the AC power supply system.

3. The electric-vehicle charging facility according to claim 1,
characterized in that,
the suitable means for determining the demand for additional electric energy can be one or more load sensors arranged at least in the AC power supply system of the electric-vehicle charging facility upstream from the transfer point.

4. The electric-vehicle charging facility according to claim 1,
characterized in that
the energy-storage device control unit charges the load-cycling-resistant energy-storage device from the general power grid, on the basis of a consumption prediction or on the basis of a prescribed profile, taking into account the charging state of the load-cycling-resistant energy-storage device.

5. The electric-vehicle charging facility according to claim 1,
characterized in that
the load-cycling-resistant energy-storage device is a flywheel energy-storage device having several storage units, each having a flywheel, whereby the storage units are connected to each other via a DC bus to the AC power supply system of the electric-vehicle charging facility via the AC/DC transformer.

6. The electric-vehicle charging facility according to claim 5,
characterized in that
the flywheel energy-storage device is configured in such a way that the voltage on the DC bus largely independent of the charging state of the flywheel energy-storage device, especially of the storage units.

7. The electric-vehicle charging facility according to claim 1,
characterized in that
the electric-vehicle charging facility comprises additional load-cycling-resistant energy-storage devices that are each connected via another AC/DC transformer to the AC power supply system of the electric-vehicle charging facility in order to store electric energy drawn from the general power grid and in order to deliver electric energy to the AC power supply system of the electric-vehicle charging facility in response to the demand.

8. The electric-vehicle charging facility according to claim 7,
characterized in that
the energy-storage device control units of the load-cycling-resistant energy-storage devices are connected via a charge management unit to the means for determining the demand for additional electric energy, and in that, depending on the charging state of the load-cycling-resistant energy-storage devices, the charge management unit selects one or several load-cycling-resistant energy-storage devices for the storage of electric energy drawn from the general power grid and for the delivery of electric energy to the AC power supply system, and this charge management unit actuates the individual energy-storage device control units of the load-cycling-resistant energy-storage devices accordingly.

9. The electric-vehicle charging facility according to claim 1,
characterized in that
the mobile storage device is the battery of an electric vehicle.

10. The electric-vehicle charging facility according to claim 1,
characterized in that
the electric-vehicle charging facility comprises one or more energy generation units that are arranged in such a way that, depending on the type of current generated, they feed the current into the electric-vehicle charging facility either upstream or downstream from the AC/DC transformer.

11. A method for the operation of an electric-vehicle charging facility according to claim 1, having an AC power supply system, suitable for the parallel fast charging of several mobile storage devices, comprising at least one fast-charging station, hooked up to the AC power supply system that is connected to the general power grid via a transfer point, and comprising at least one load-cycling-resistant energy-storage device having an energy storage device control unit connected to at least one suitable means for determining the demand for additional electric energy in the AC power supply system, comprising the following steps:
the load-cycling-resistant energy-storage device is charged via the AC/DC transformer from the general power grid if the load-cycling-resistant energy-storage device not yet fully charged and if no demand additional electric energy in the electric-vehicle charging facility was determined by the suitable means, and
electric energy is delivered to the AC power supply system of the electric-vehicle charging facility from the load-cycling-resistant energy-storage device, initiated by the energy-storage device control unit, so that neither the general power grid nor the AC power supply system of the electric-vehicle charging facility is overloaded by the parallel fast-charging operations, once the demand for additional electric energy has been determined by the suitable means and an appropriate demand signal has been sent to the energy-storage device control unit.

12. The method according to claim 11,
characterized in that
the charging of the load-cycling-resistant energy-storage device is based on a consumption prediction or on a prescribed profile, taking into account the charging state of the load-cycling-resistant energy-storage device.

13. The method according to claim 11, whereby the electric-vehicle charging facility comprises additional load-cycling-resistant energy-storage devices that are each connected via an additional AC/DC transformer to the AC power supply system of the electric-vehicle charging facility, and whereby the energy-storage device control units of the load-cycling-resistant energy-storage devices are connected via a charge management unit to the means for determining the demand additional electric energy, the method comprises the following steps:
one or several load-cycling-resistant energy-storage devices for the storage of electric energy drawn from the general power grid are selected by the charge management unit, depending on the charging state of the load-cycling-resistant energy-storage devices in the absence of a demand for additional electric energy in the AC power supply system, and
one or several load-cycling-resistant energy-storage devices for the delivery of electric energy to the AC power supply system are selected, and subsequently, the selected load-cycling-resistant energy-storage devices are actuated by the appertaining energy-storage device control units of the load-cycling-resistant energy-storage devices.

14. A method for retrofitting an electric-vehicle charging facility having an existing AC power supply system that is connected to the general power grid via a transfer point in order to create an electric-vehicle charging facility according to claim 1, having a load-cycling-resistant energy-storage device, suitable for the parallel fast charging of several mobile storage devices, comprising the following steps:
the AC power supply system of the electric-vehicle charging facility is adapted to the total current that can be anticipated for the parallel fast charging, if the existing AC power supply system is not suitable for this total current,
the load-cycling-resistant energy-storage device is hooked up by means of an AC/DC transformer to the conceivably adapted AC power supply system of the electric-vehicle charging facility order to store electric energy drawn from the general power grid and in order to deliver electric energy to the AC power supply system of the electric-vehicle charging facility in response to the demand,
a suitable means, preferably comprising one or more load sensors, for determining the demand for additional electric energy is incorporated into the electric-vehicle charging facility, and
the means is connected to an energy-storage device control unit of the load-cycling-resistant energy-storage device, said unit being provided to initiate the delivery of electric energy to the AC power supply system on the basis of the determined demand, so that neither the general power grid nor the AC power supply system of the electric-vehicle charging facility is overloaded by the parallel fast-charging operations.

15. The method according to claim 14,
characterized in that
on the basis of an appropriate demand prognosis, the steps consisting of hooking up, incorporating and connecting can be carried out for additional load-cycling-resistant energy-storage devices that are then each connected via another AC/DC transformer to the AC power supply system of the electric-vehicle charging facility.
